(19) United States
(12) Patent Application Publication
(10) Pub. No.: US 2012/0284214 A1
(43) Pub. Date: Nov. 8, 2012

(54) SOFTWARE, DISPLAY AND COMPUTER SYSTEM FOR RUNNING AND PRESENTING IMAGES AS PART OF THERAPY FOR ENHANCING NUMERICAL COGNITION

(75) Inventors: Tanja Käser, Zurich (CH); Matthias Ringwald, Zurich (CH); Urban Weber, Schaffhausen (CH); Gian-Marco Baschera, Zurich (CH); Michael von Aster, Erlenbach (CH); Markus Gross, Uster (CH)

(73) Assignee: Dybuster AG, Zurich (CH)

(21) Appl. No.: 13/415,612

(22) Filed: Mar. 8, 2012

Related U.S. Application Data
(60) Provisional application No. 61/450,526, filed on Mar. 8, 2011.

(51) Int. Cl. G06F 15/18

(52) U.S. Cl. 706/12

(57) ABSTRACT

A method of presenting training materials for training users with developmental dyscalculia or related learning difficulties includes determining a number or a numerical expression to present as part of training the user in developing internal maps to assist with overcoming a learning difficulty, whereby the user can increase a tendency to establish an internal neurological representation of numbers and numerical expression, wherein a numerical expression is a sequence of at least one number and at least one mathematical operator, generating a representation in a virtual space of an arrangement of numbers, including a number line and a representation of the number or the numerical expression, taking into account a resolution of the computer-controlled display that is to be used, and presenting to the user, using the computer-controlled display, a view of the virtual space showing the number line and the representation of the number or the numerical expression.

### CROSS-REFERENCE TO RELATED APPLICATIONS

The present disclosure may be related to the following commonly assigned applications/patents:

This application claims priority from and is a non-provisional of U.S. Provisional Patent Application No. 61/450,526, filed Mar. 8, 2011 entitled “SOFTWARE, DISPLAY AND COMPUTER SYSTEM FOR RUNNING AND PRESENTING IMAGES AS PART OF THERAPY FOR ENHANCING NUMERICAL COGNITION” which is hereby incorporated by reference, as if set forth in full in this document, for all purposes.

The respective disclosures of these applications/patents are incorporated herein by reference in their entirety for all purposes.

### FIELD OF THE INVENTION

The present invention relates to displays, and computer systems, for controlling displays and receiving inputs as part of a therapeutic training regime for those with dyscalculia and to enhance numerical cognition in humans.

### BACKGROUND

Developmental dyscalculia (“DD”) is a specific learning disability affecting the acquisition of arithmetic skills. Genetic, neurobiological, and epidemiological evidence indicates that developmental dyscalculia, like other specific learning disabilities, is a brain-based disorder, although poor teaching and environmental deprivation have also been implicated in its aetiology. See, e.g., [Shalev]. The prevalence of developmental dyscalculia in Germany and Switzerland is about 6%. See, e.g., [von Aster2005].

In view of this situation, systems for training those with developmental dyscalculia are needed.

### REFERENCES

[Dehaene] Dehaene, S., “Varieties of Numerical Abilities”, Cognition 44:1-42 (1992).

[Kast] Kast, M., Meyer, M., Vögeli, C., Gross, M., and Jäncke, L., “Computer-Based Multisensory Learning in Children with Developmental Dyslexia”, Restorative Neurology and Neuroscience 25:355-369 (2007).

[Kucian] Kucian, K., Grond, U., Rotzer, S., Henzi, B., Schönmann, C., Plangger, F., Gälli, M., Martin, E., and von Aster, M. “Mental Number Line Training in Children with Developmental Dyscalculia”, NeuroImage (accepted).

[Shalev] Shalev, R., and von Aster, M. G., “Identification, Classification, and Prevalence of Developmental Dyscalculia”, Encyclopedia of Language and Literacy Development, pp. 1-9 (2008).

[Stern] Stern, E., “Kognitive Entwicklungspsychologie des Mathematischen Denkens”, in von Aster, M. G., and Lorenz, J. H., “Rechenstörungen bei Kindern: Neurowissenschaft, Psychologie, Pädagogik” (2005).

[von Aster2005] von Aster, M. G., Kucian, K., Schweiter, M., and Martin, E., “Rechenstörungen im Kindesalter”, Monatsschrift in Kinderheilkunde 153:614-622 (2005).

[von Aster2007] von Aster, M. G., and Shalev, R., “Number Development and Developmental Dyscalculia”, Developmental Medicine and Child Neurology 49:868-873 (2007).

### SUMMARY OF THE INVENTION

A method (and corresponding apparatus) of presenting training materials for training users with developmental dyscalculia or related learning difficulties includes determining a number or a numerical expression to present as part of training the user in developing internal maps to assist with overcoming a learning difficulty, whereby the user can increase a tendency to establish an internal neurological representation of numbers and numerical expression, wherein a numerical expression is a sequence of at least one number and at least one mathematical operator, generating a representation in a virtual space of an arrangement of numbers, including a number line and a representation of the number or the numerical expression, taking into account a resolution of the computer-controlled display that is to be used, and presenting to the user, using the computer-controlled display, a view of the virtual space showing the number line and the representation of the number or the numerical expression.

The following detailed description together with the accompanying drawings will provide a better understanding of the nature and advantages of the present invention.

### BRIEF DESCRIPTION OF THE DRAWINGS

FIG. 1 is a triple code model for a number.

FIG. 2 is a 4-step development model with the shaded area in the lower portions of the figure denoting the increasing capacity of the working memory.

FIG. 3 is an illustration of a number with a hand, a visual Arabic form, and a number line.

FIG. 4 is a visualization of a number with corresponding color and topology.

FIG. 5 is a visualization of number using colored blocks (FIG. 5A), colored blocks integrated into the number ray (FIG. 5B), and colored blocks viewed from a precomputed angle (FIG. 5C).

FIG. 6 is an illustration of landing game in the number range from 0-100.

FIG. 7 is an illustration of addition game in the number range from 0-100.

FIG. 8 is an illustration of an extract of skills, the dependencies among them, and associated tasks in second area.

FIG. 9 illustrates example computer hardware useable for implementing a training system.

FIGS. 10A and 10B are flowcharts of the therapy software for enhancing numerical cognition.

### DETAILED DESCRIPTION OF THE INVENTION

In study managed by some of the present inventors, a computer-based training program for children with developmental dyscalculia was developed and evaluated. Some discussion of that study is provided in Appendix A. In general, children with and without DD could benefit from the training. This was indicated by: (i) improved spatial representation of numbers and (ii) the number of correctly solved arithmetical problems. During the training, the control children showed the typical fronto-parietal network brain activations associated with number processing. In contrast, dyscalculics showed main activation in medial frontal areas. Statistical group comparison corroborated that children with DD showed less activation in bilateral parietal regions. After training, less brain activation was evident in mainly the frontal lobes in both groups. Taken together, the training improved the spatial representation of numbers and arithmetical performance. Reduced brain activation in children with DD may reflect neurophysiological deficits in core regions for number processing. After the training, children rely less on frontal areas associated with reduced working memory and attentional needs. The study showed that the training leads to an improved spatial representation of the mental number line, which facilitates processing of numerical tasks, and hence requires less neuronal capacity.

### Computerized Training System

In the training system described below, users/trainees/students interact with a computer system that provides output to a display visible to the user/trainee/student (hereinafter referred to as “user” for ease of reading) based on instructions in a software program following the designs herein. The training system is interactive, in that it takes user input and makes program decisions based on that user input. The program code that represents the software program might be stored on computer readable medium, such as CD-ROMs or stored online for later distribution and/or use. In some cases, the computer hardware can be a conventional desktop computer, laptop, handheld computing device, mobile telephone, tablet or other suitable hardware.

More details of computer hardware and software that can be used to accept inputs, process and transform data, generate display images and display those images are described below, but first some displays and processing are described.

The software takes into account two important models of dyscalculia and the development of mathematical understanding, namely the “triple-code model” and the “four-step developmental model” as explained more below.

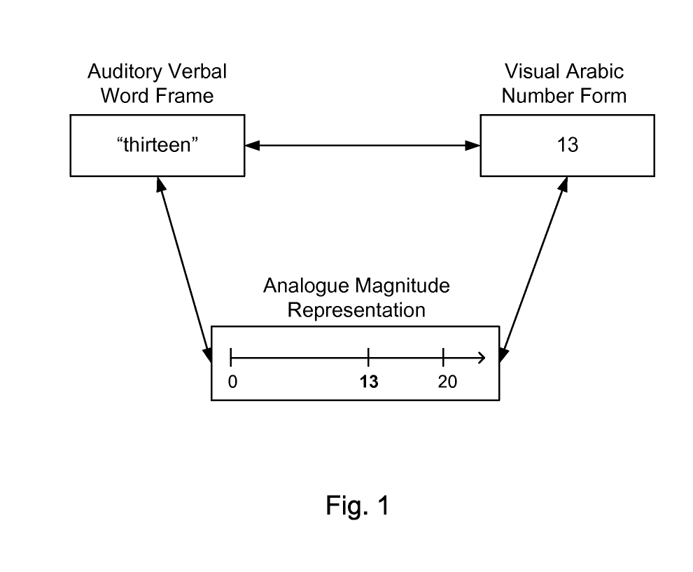

FIG. 1 illustrates an example of a triple-code model for a number (in this case, the number “13” or “thirteen”, a number between zero and 20 that is closer to 20 than it is to zero). Each of the three modules for number processing use a different representation of numbers. The triple-code model is well-known. See, for example, [Dehaene].

In the verbal module (auditory verbal word frame), numbers are represented as number words (e.g., “thirteen”). In the Arabic module (visual Arabic number form), the Arabic notation is used for the representation of numbers (e.g., “13”). In the analogue module (analogue magnitude representation), numbers are depicted as an analogue locus on an internal number line (e.g., see box 100 in FIG. 1). There are different abilities attributed to each module. Counting, exact mental calculation, and arithmetical fact retrieval are mainly executed in the auditory verbal word frame. The visual Arabic number form is responsible for parity judgments and multi-digit operations. Approximation tasks, as well as number comparisons, are attributed to the analogue magnitude representation.

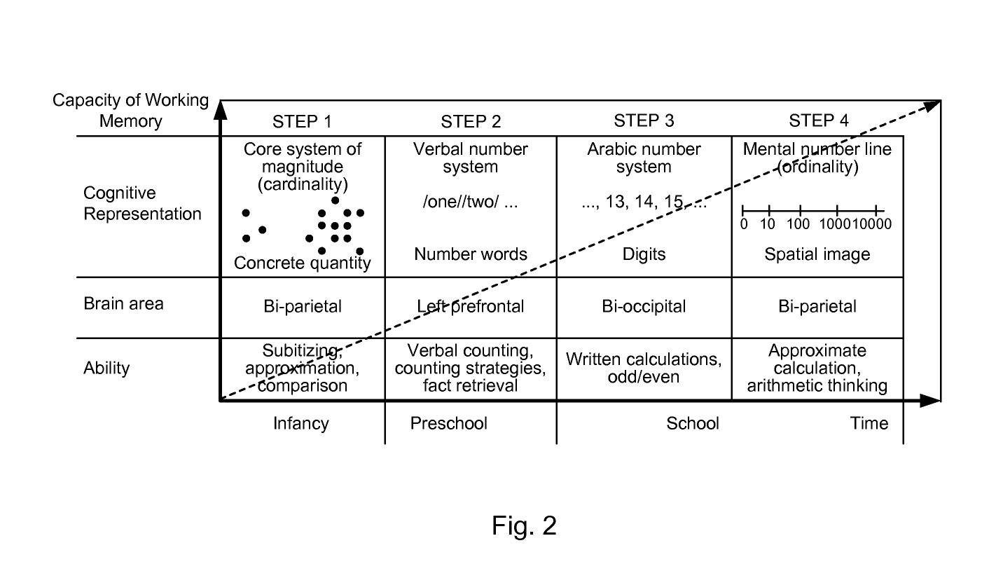

FIG. 2 illustrates the four-step developmental model. According to that model, the triple-code modular system develops hierarchically over time depending on the capacity and availability of functions of general intelligence (attention, working memory, processing speed) and on experiences. See, e.g., [von Aster2007]. The present invention is not limited by the models, but the models are useful for explaining aspects of the system.

Already babies can capture and differentiate sets according to their cardinality. This core-system representation of cardinal magnitude and its functions provide the basic meaning of numbers (step 1 in FIG. 2). This is a necessary precondition for children to associate a perceived number of objects with spoken or written symbols. The linguistic symbolization (step 2 in FIG. 2) as well as abilities such as the principles of counting, increase/decrease schemes and simple arithmetic operations performed by counting, develops in pre-school age without systematical teaching. The Arabic symbolization (step 3 in FIG. 2) of numbers is then learned in school. It is a precondition for the development of the analogue magnitude representation.

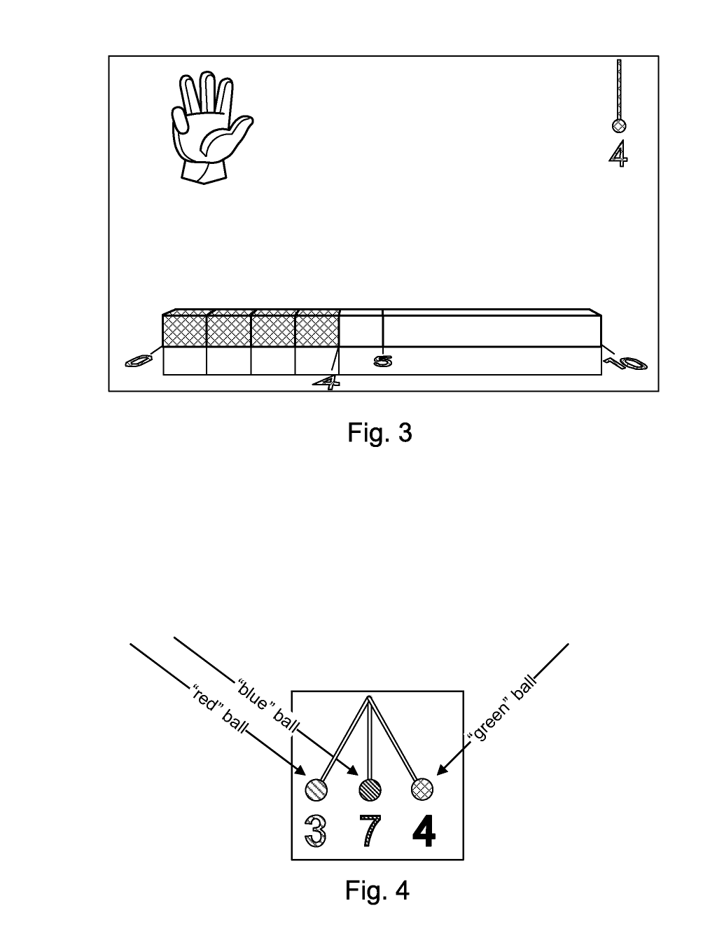

FIG. 3 illustrates an example of a display for a multi-code representation of a number in a training system, which illustrates the number “4” with a hand holding up four fingers (upper left of FIG. 3). This could instead be text, auditory or another representation, possibly depending on the expected reading level of the user. Also, shown as part of the multi-code representation is a visual Arabic form (upper right), and a number line (lower portion), each illustrating a “4”.

The three different number representations and the translation between them form the basis of number processing. The training system can take this into account when providing, for example, a special number design to enhance these representations and at the same time facilitate numerical understanding. In the training system, the properties of numbers can be encoded with auditory and visual cues such as color, form and topology. The different positions (one, ten, hundred) of the place-value system can be represented with different colors.

FIG. 4 enhances this aspect, by showing a visualization graph that can be displayed on a display to a user, where each digit of a number is shown attached to a different branch. In FIG. 4, the representation facilitates the development of the Arabic symbolization as well as the translation between the auditory verbal word frame and the visual Arabic number form. Each of the Arabic “places” (e.g., hundreds, tens, ones) might be presented by a particular color (e.g., red, blue, green, respectively) and used consistently throughout the program.

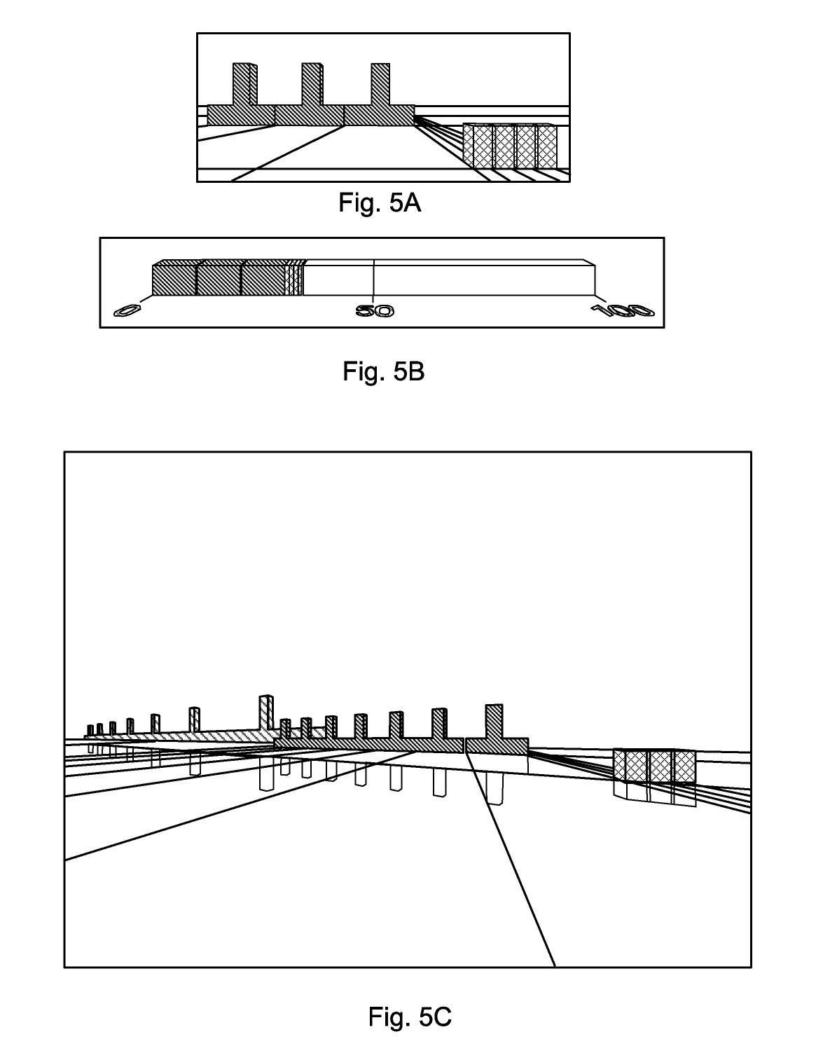

The cardinal magnitude of numbers can be emphasized by illustrating the number as a composition of blocks with different colors, i.e., as an assembly of one, ten and hundred blocks, as shown in FIG. 5. In FIG. 5A, the larger blocks in the background (or at least appear to be in the background) might be blue, signifying tens, while the closer blocks are green, signifying ones. In this way, the display can highlight the fact that numbers are composed of other numbers and again refer to the Arabic symbolization.

These different blocks are arranged on a line from left to right to make a connection to the analogue magnitude representation. To stress this representation even more, a display along the lines of FIG. 5B can be used to show blocks directly integrated in the number ray, thus providing a diverse perspective of the blocks. As should be understood, the displays shown in various figures and described herein can be generated and presented to a user using a display device (not shown explicitly in the figures).

In various figures, the display is in apparent three-dimensional space (“3D”) in that a viewer would understand that it is a view of virtual 3D space, projected onto a two-dimensional (“2D”) viewing surface. In specific implementations, the number line is determined in 3D but then ultimately displayed on a 2D screen, as shown, for example, in FIG. 5C. In other implementations, it is actually perceived in 3D using a 3D display. In some cases, it is not actually a line in 3D, but appears to be a line for some 2D projections. Not only can delineations be perceived, but the intervals on the number line are perceived with the correct proportions of their numerical value.

In the example of FIG. 5C, there are 100 s units (which, if color is used consistently, might be red blocks), 10 s units (which, if color is used consistently, might be blue blocks), and 1 s units (which, if color is used consistently, might be green blocks). It should be noted that while 100 s units are perceived as being ten times as long as 10 s units, and 10 s units are perceived as being ten times as long as 1 s units, they all can appear to scale on the same display or screen, with the 1 s units closer to the viewer in the virtual 3D space than the 100 s units or 10 s units. In this example, the number “773” is represented. The relative scale is apparent from the foreground of the figure, noting that the approximately left-to-right line one which the 1 s units reside intersects the lines emanating from between the 10 s units. The lines emanating from between the 10 s units are perceived as all being perpendicular to the fronts of the 10 s units and are therefore parallel lines in the 3D virtual space (although they are perspective lines in the 2D projection) and it appears in scale with the 1 s units (i.e., it would be visually apparent that it would take 10 1 s units to span adjacent perspective lines that bound a 10 s unit).

All these special number designs might be shown simultaneously in game formats in the programs implementing this system.

### Software Design

A particular software design will now be described. It should be understood that such software can be executed by a computer with a display viewable by the user. A complete mathematical understanding of a number can require the presence of all three number representations and the translation between them, as well as the ability to master operations and procedures with numbers, and the software described here takes that into account, dividing into two structured areas: representation and operations. Each area comprises individual therapy games constructed in a way to use the special number design.

### Cognitive Number Representation and Numerical Understanding

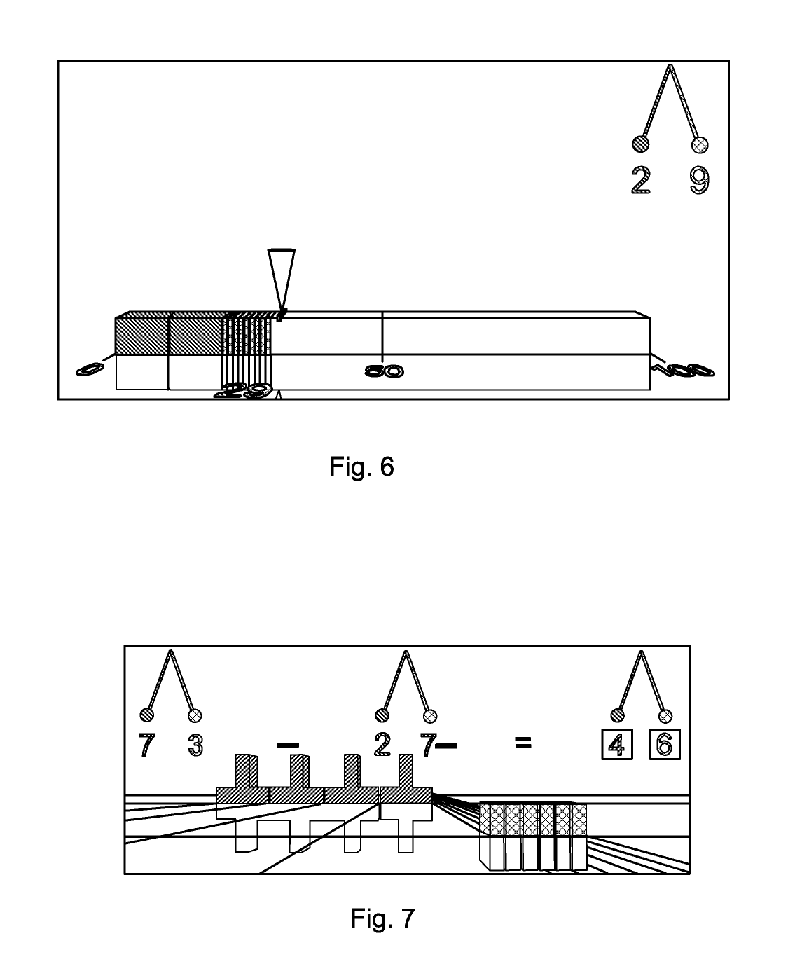

The first area of the program focuses on cognitive number representation and numerical understanding as well as transcoding between different numerical representations. Furthermore, the games concentrate on different aspects of numerical understanding that supports the development of cardinal and ordinal principles of numerosity, such as those described in [Stern]. Basic games feature either a specific translation between two different number representations or highlight an aspect of numerosity. The more difficult games require a combination of translations and knowledge about principles of numerosity. One important game in this area is, for example, the landing game illustrated by an example snapshot in FIG. 6. In this game, the user needs to find the analogue position of an Arabic digit on a number ray. In the display, the number is shown with places-colored dots and Arabic digits in the upper right and the lower portion showing where the number needs to land (as well as showing the numbers—in this example snapshot, 0, 29, 50 and 100—using places-colored digits, i.e., the places of the digits are color-coded as part of the number).

The second area of the program focuses on cognitive operations and procedures. Each of the games in this area trains a mathematical operation at a specific difficulty level. To consolidate the skills acquired in the first area, the representation of the task and its solution makes use of different number representations. The games in this area are hierarchically ordered according to their difficulty.

The program differentiates between two types of difficulty. The so-called vertical difficulty denotes the inherent difficulty of the task, e.g., an addition in the number range from 0-10 is easier than an addition in the range from 0-100. The horizontal difficulty depends on the presentation of the task and on the allowed means to solve the task, e.g., solving an addition with material is easier than doing a mental calculation. An example of a subtraction with its corresponding representation is illustrated in FIG. 7.

### Game Control

In order to offer optimal learning conditions, a specific embodiment of the software adapts to the needs of a specific user. At the beginning of the training, all users start with the same game. After each input, the software estimates the actual knowledge state of the user and displays a new task adjusted to this state. In this way, the velocity of advancement can be adapted to each user and specific problems of a user can be recognized and addressed.

In order to do so, the software holds an internal representation of the user's knowledge. In a specific embodiment, the user's knowledge is modeled using a dynamic Bayes net. This net comprises a directed acyclic graph representing different mathematical skills and the dependencies between them. These skills can again be associated with the two areas of the software:

(1) The first area contains skills regarding number representations and general number understanding. The skills are ordered hierarchically according to two criteria. The coarse criterion is the separation between the different number ranges. Within each number range, the hierarchical ordering is based on the four-step development model.

(2) Skills regarding procedures and operations with numbers are attributed to the second area. Again, a hierarchical ordering of the skills is performed. Here, the first criterion is the split into the different operations, i.e., addition and subtraction. Within a specific operation, the program orders the skills according to their vertical and horizontal difficulty described above.

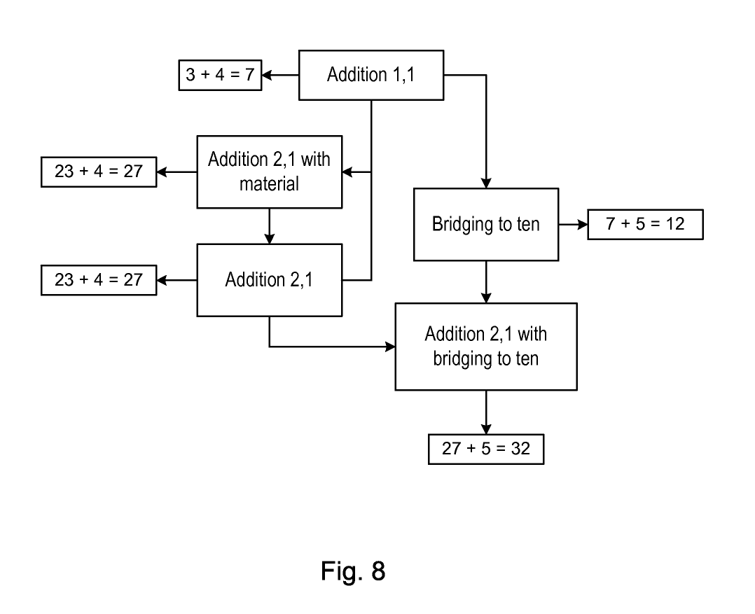

As the skills of the user are not viewable directly, the software infers them by posing specific tasks and evaluating the user actions. Such observations indicate the presence or absence of a particular skill with some probability. Therefore, the software assigns types of tasks and their outcome to the different skills, as illustrated by FIG. 8.

Each input of a child in training or other user is evaluated and fed into the Bayes net accordingly. In this way, the net can be updated with each input of the student and the training system can compute an estimate of the student's actual knowledge state. Based on this estimate, the next game to play is then selected and adapted to the specific student.

### Study

In a study of the software with normally achieving and dyscalculic children, a cross-over design can be used with both groups of children divided into a training group, a control training group and a waiting group and have them play with the software for specified periods (e.g., 20 minutes per day, five days per week, for six weeks). Control training might be performed using the computer-based dyslexia therapy software from Dybuster. See, e.g., [Kast], for examples. To prove the effect of the training and its temporal stability, psychometric data can be collected at four specific time points. Tests include measurements regarding intelligence, attention and working memory as well as different methods to measure number processing and calculation, math anxiety and the so called “spontaneous focusing on numerosity” (“SFON”).

### Hardware Example

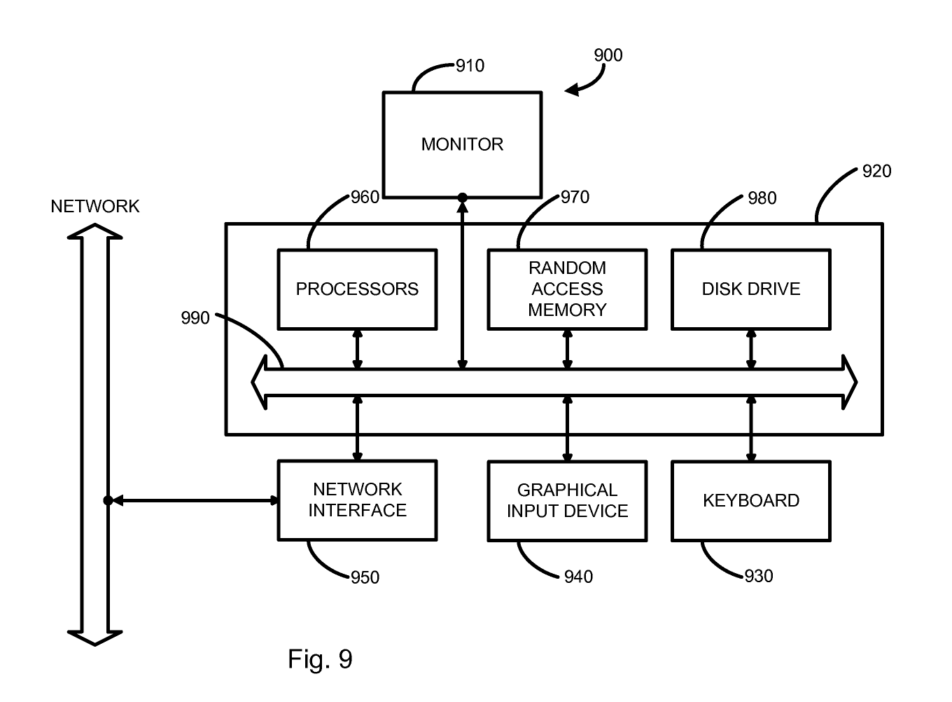

FIG. 9 is a block diagram of typical computer system 900 according to an embodiment of the present invention that might be used to implement the training system, to accept inputs, perform processes in software using data, and outputting particular display elements as indicated by the software processes. Thus, this computer system 900 could be used to display images shown in the figures of this application.

Computer system 900 may include a display 910, computer 920, a keyboard 930, a user input device 940, computer interfaces 950, and the like. In various embodiments, display (monitor) 910 may be embodied as a CRT display, an LCD display, a plasma display, a direct-projection or rear-projection DLP, a microdisplay, or the like. In various embodiments, display 910 may be used to visually display user interfaces, images, games, instructions, or the like.

In various embodiments, user input device 940 is typically embodied as a computer mouse, a trackball, a track pad, a joystick, wireless remote, drawing tablet, voice command system, eye tracking system, and the like. User input device 940 typically allows a user to select objects, icons, text and the like that appear on the display 910 via a command such as a click of a button or the like.

Embodiments of computer interfaces 950 typically include an Ethernet card, a modem (telephone, satellite, cable, ISDN), (asynchronous) digital subscriber line (DSL) unit, FireWire interface, USB interface, and the like. In various embodiments, computer 920 typically includes familiar computer components such as a processor 960, and memory storage devices, such as a random access memory (RAM) 970, disk drives 980, and system bus 990 interconnecting the above components. An operating system might provide typical operating system functionality.

RAM 970 and disk drive 980 are examples of computer-readable tangible media configured to store data such as metadata associated with assets stored in a file repository and the like. Types of tangible media include magnetic storage media such as floppy disks, networked hard disks, or removable hard disks; optical storage media such as CD-ROMS, DVDs, holographic memories, or bar codes; semiconductor media such as flash memories, read-only-memories (ROMS); battery-backed volatile memories; networked storage devices, and the like.

In the present embodiment, computer system 900 may also include software that enables communications over a network such as the HTTP, TCP/IP, RTP/RTSP protocols, and the like. In alternative embodiments of the present invention, other communications software and transfer protocols may also be used, for example IPX, UDP or the like.

FIG. 9 is representative of a computer system capable of embodying the training system described above. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers. Further, the use of other micro processors are contemplated, such as Core™ microprocessors from Intel; Phenom™, Turion™ 64, Opteron™ or Athlon™ microprocessors from Advanced Micro Devices, Inc; and the like. Further, other types of operating systems are contemplated, such as WindowsVista®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board.

In other embodiments of the present invention, combinations or sub-combinations of the above disclosed invention can be advantageously made. The block diagrams of the architecture and graphical user interfaces are grouped for ease of understanding. However it should be understood that combinations of blocks, additions of new blocks, re-arrangement of blocks, and the like are contemplated in alternative embodiments.

### Conclusion

We presented a computer-based software and hardware system for the acquisition of central components of number processing and mathematical understanding. The structure of the software can be based on neurocognitive models. The number design developed for the software enhances important aspects of number understanding and facilitates learning of important concepts of number. The adaptivity of the software allows for adjustment of learning speed and focusing on specific problems of each particular user. Pilot tests with a first prototype have shown that the playful environment and the interaction components increase motivation of children positively, one of the most important qualities of a successful training The software can be expected to show progress in mathematical understanding as well as other effects, such as increased motivation.

In the examples shown, displays and software for running displays, including computer to handle input and output, provides for a system to teach components of number processing and representation. Learning processes are supported through multimodal cues encoding different properties of number. The learning environment can use 3D graphics and interaction components. The learning system can provide adaptation as the user interacts with the system and build up a computer-based training program for children with developmental dyscalculia and similar development aspects to improve the spatial representation of numbers and arithmetical performance.

By careful selection of the method of displaying mathematical content, the viewer can be expected to establish his/her internal neurological representation of numbers and mathematical operations on numbers. Numbers can be shown in multiple ways, such as by the use of Arabic numbers with visual structures, color, etc. to distinguish place and relative value. In some approaches, the 2D number line in 2D is presented as a 2D view of a 3D space comprising a z-axis component configured such that the spacing of intervals on the number line correctly represents their numerical value and corresponds to a predetermined z depth allowing the line to delineate logarithmic increments in a manner to be displayed to a user that allows the user to perceive delineations not perceptible using a 2D model.

Mathematical operations of adding and subtracting might be presented by displaying the possible range of answers within which the addition and subtraction is to be performed as a 3D volume, which would not be possible using 2D representations or 3D real world models. Some models of the number line in 3D provide perceptually maintained sizes of the intervals on the number line correctly when projecting it to 2D by a method of mapping the sizes of the intervals to a predetermined depth offset in the direction of the z-axis. Projecting the 3D model of the number line to two dimensions defining the positioning of the camera and the viewing direction of the camera, can result in the entire number line fitting on a display screen (e.g., even where there are more numbers being dealt with than there are lines of pixels, such as displaying the number line for 0 to 2000 using a display only being 1024 pixels wide), and do so without scrolling, distortion, or zooming while still being perceived by the user as one line.

In some models, delineations on the number line shift and intervals merge when passing the interval boundaries by mathematical operations, to show movement of the intervals on predetermined paths and morphing the model of one interval into the model of the second interval, which would not be possible using real world 3D representations of the intervals. A linear representation of the number line might move into the 3D model of the number line and vice versa by disassembling a linear representation into intervals, moving them in the z-axis direction and performing a camera flight along a predetermined path, allowing the user to associate one representation with the other.

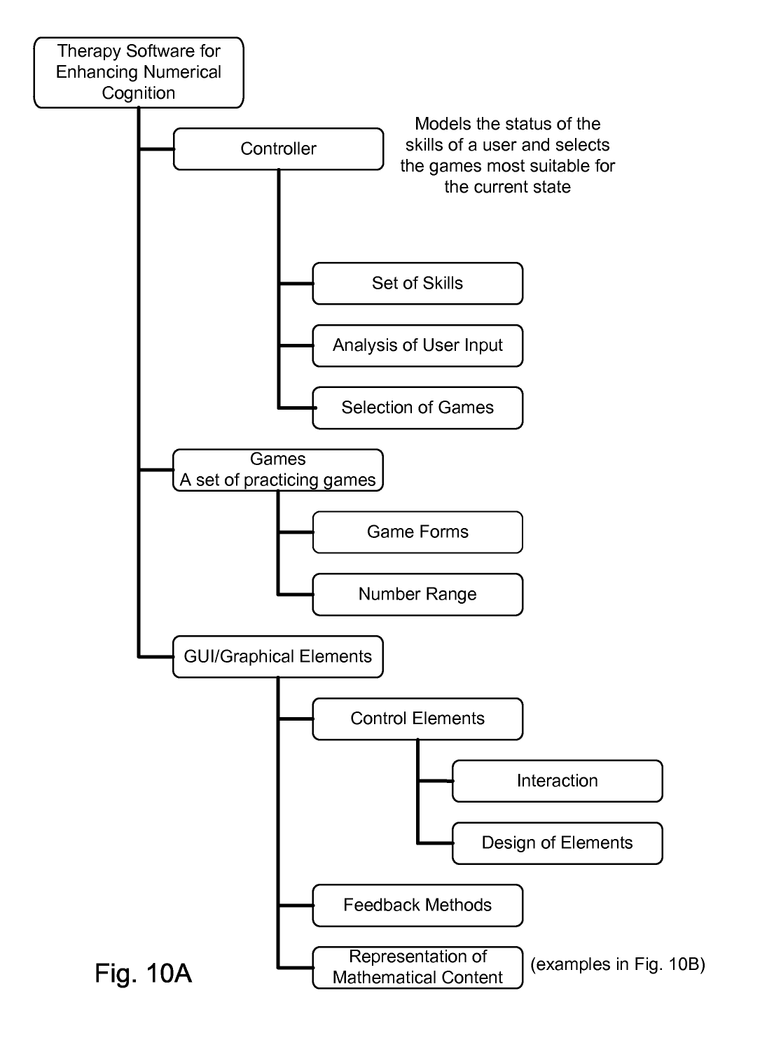

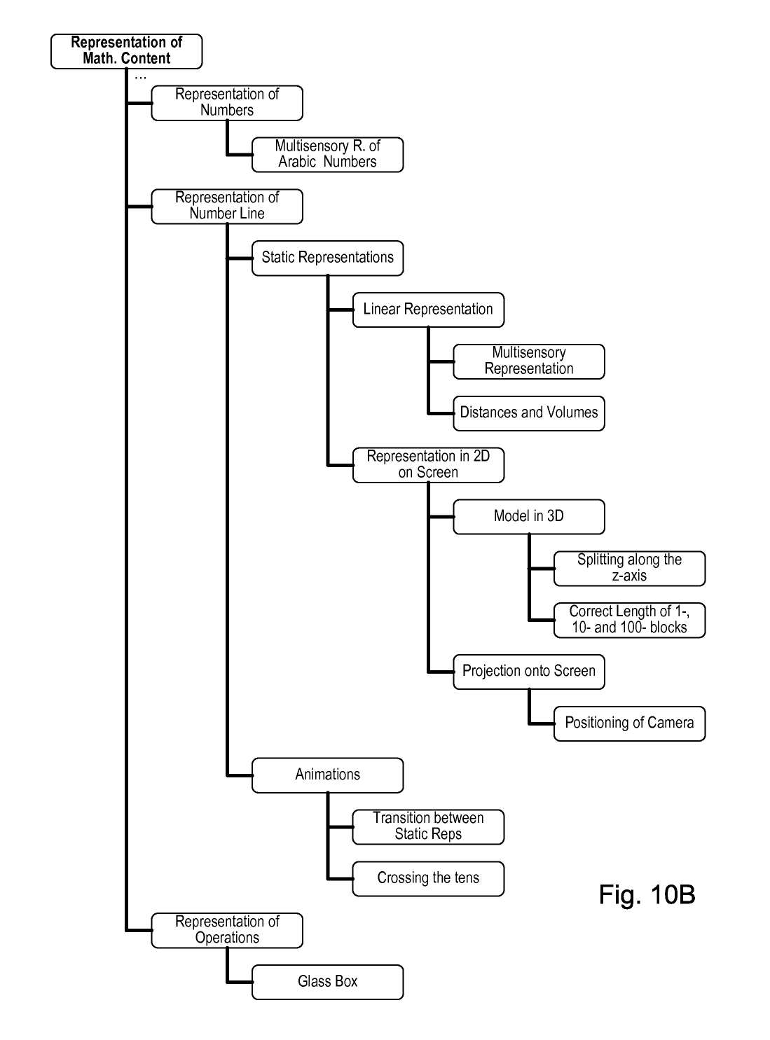

As has now been shown, software can provide for the acquisition of central components of number processing and representation as well as mathematical understanding. Flowcharts of example software might be as shown in FIGS. 10A and 10B. Other variations are possible, however. The learning process is supported through multimodal cues encoding different properties of numbers. A learning environment features 3D graphics and interaction components and thus allows immersion in a playful 3D world. To offer optimal learning conditions, a Bayes net user model completes the software and allows adaptation to a specific user.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

What is claimed is:

1. A method of presenting training materials for training users with developmental dyscalculia or related learning difficulties, the method for use with a computer-controlled display, the method comprising:
determining a number or a numerical expression to present as part of training the user in developing internal maps to assist with at least partially overcoming a learning difficulty, whereby the user can increase a tendency to establish his or her internal neurological representation of numbers and numerical expression, wherein a numerical expression is a sequence of at least one number and at least one mathematical operator;
generating a representation in a virtual space of an arrangement of numbers, including a number line and a representation of the number or the numerical expression, taking into account a resolution of the computer-controlled display that is to be used; and
presenting to the user, using the computer-controlled display, a view of the virtual space showing the number line and the representation of the number or the numerical expression.

2. The method of claim 1, wherein the representation of the number that is presented, is presented as an Arabic number with at least one display variation unrelated to the digits used for the number, with the display variation corresponding to a position of the number with its magnitude in the decimal system.

3. The method of claim 2, wherein the display variation is a variation of color with different colors corresponding to different decimal positions.

4. The method of claim 1, wherein the view is a two-dimensional view and the representation in the virtual space is representation of the number line in three dimensions of the virtual space, comprising a z-axis component configured such that spacing of intervals on the number line correctly represents their numerical value and correspond to a predetermined z-depth allowing the number line to delineate logarithmic increments to convey to the user delineations not conveyable with a two-dimensional model.

5. The method of claim 1, wherein the numerical expression comprises expressions involving mathematical operations of adding and subtracting, and wherein the representation in the virtual space displaying a possible range of answers using the third dimension to account for display limitations.

6. The method of claim 1, wherein the representation in the virtual space is such that numbers greater than the number of pixels of resolution in one dimension of the computer-controlled display are displayable using a three-dimensional model of the number line such that the entire number line fits within the display without requiring scrolling, distortion, or zooming, while being perceptible as one line.

7. The method of claim 1, wherein the representation in the virtual space includes a representation of delineations on the number line, their shifts and merging of intervals.

8. The method of claim 1, further comprising a representation that is convertible between a two-dimensional view and a three-dimensional view.
